(19) United States
(12) Patent Application Publication
(10) Pub. No.: US 2021/0403040 A1
(43) Pub. Date: Dec. 30, 2021

(54) INFORMATION PROCESSING DEVICE, INFORMATION PROCESSING SYSTEM, PROGRAM, AND VEHICLE

(71) Applicant: TOYOTA JIDOSHA KABUSHIKI KAISHA, Toyota-shi (JP)

(72) Inventors: Tooru NAKANISHI, Nagakute-shi (JP); Tadashi YAMADA, Toyota-shi (JP); Josuke YAMANE, Nissin-shi (JP); Mitsuhiro MIURA, Toyota-shi (JP); Tomo SASAKI, Toyota-shi (JP); Tomoyuki KOZUKA, Toyota-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 17/341,494

(22) Filed: Jun. 8, 2021

(30) Foreign Application Priority Data
Jun. 29, 2020 (JP) 2020-112020

(51) Int. Cl. B60W 60/00; B60N 2/00; G01C 21/34; B60W 40/08

(52) U.S. Cl. CPC B60W 60/0013; B60N 2/002; B60W 2530/00; B60W 40/08; B60W 2540/22; G01C 21/3407

(57) ABSTRACT

An information processing device includes a control unit. The control unit determines a service content fit for an occupant by acquiring first information from a first sensor installed in a vehicle cabin of a vehicle for detecting the occupant and second information from a second sensor for detecting opening and closing of a door of the vehicle, estimating composition information of the occupant based on the first information that is acquired, estimating mood information of the occupant based on the second information that is acquired, and comparing the composition information and the mood information that are estimated with past data for another occupant in which the composition information and the mood information are associated with a service content received at a service facility.

### CROSS-REFERENCE TO RELATED APPLICATION

This application claims priority to Japanese Patent Application No. 2020-112020 filed on Jun. 29, 2020, incorporated herein by reference in its entirety.

### BACKGROUND

### 1. Technical Field

The present disclosure relates to an information processing device, an information processing system, a program, and a vehicle.

### 2. Description of Related Art

There is known a technique for improving the ease of getting on and off a vehicle when the vehicle is parked. For example, Japanese Unexamined Patent Application Publication No. 2019-137079 (JP 2019-137079 A) discloses a driving support device that assists a driving operation when a vehicle is parked in a predetermined parking space. The driving support device acquires the characteristic information of each occupant who gets on the vehicle, and determines the parking position of the vehicle in the parking space based on the acquired characteristic information of the occupant.

### SUMMARY

With such a technique in the related art, it is possible to improve the ease of getting on and off the vehicle when the vehicle is parked, and to improve, for example, the rate of attracting customers to service facilities and accordingly the management efficiency. However, a technique that optimizes services for the occupants based on the composition and the mood of the occupants of the vehicle and that leads to improvement of management efficiency has not been sufficiently considered.

An object of the present disclosure made in view of such circumstances is to make it possible to optimize the services for the occupants based on the composition and the mood of the occupants.

An information processing device according to an embodiment of the present disclosure includes: a control unit that determines a service content fit for an occupant by acquiring first information from a first sensor installed in a vehicle cabin of a vehicle for detecting the occupant and second information from a second sensor for detecting opening and closing of a door of the vehicle, estimating composition information of the occupant based on the first information that is acquired, estimating mood information of the occupant based on the second information that is acquired, and comparing the composition information and the mood information that are estimated with past data for another occupant in which the composition information and the mood information are associated with a service content received at a service facility.

A program according to an embodiment of the present disclosure causes an information processing device to perform operations including: acquiring first information from a first sensor installed in a vehicle cabin of a vehicle for detecting an occupant and second information from a second sensor for detecting opening and closing of a door of the vehicle; estimating composition information of the occupant based on the first information that is acquired; estimating mood information of the occupant based on the second information that is acquired; comparing the composition information and the mood information that are estimated with past data for another occupant in which the composition information and the mood information are associated with a service content received at a service facility; and determining a service content fit for the occupant.

A vehicle according to an embodiment of the present disclosure includes a control unit that determines a service content fit for an occupant by acquiring first information from a first sensor installed in a vehicle cabin of the vehicle for detecting the occupant and second information from a second sensor for detecting opening and closing of a door of the vehicle, estimating composition information of the occupant based on the first information that is acquired, estimating mood information of the occupant based on the second information that is acquired, and comparing the composition information and the mood information that are estimated with past data for another occupant in which the composition information and the mood information are associated with a service content received at a service facility.

With the information processing device, the information processing system, the program, and the vehicle according to the embodiments of the present disclosure, it is possible to optimize the services for the occupants based on the composition and the mood of the occupants.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a configuration of an information processing system including an information processing device according to an embodiment of the present disclosure;

FIG. 2 is a functional block diagram showing a schematic configuration of each of the information processing device, a vehicle, and a terminal device shown in FIG. 1;

FIG. 3 is a first diagram illustrating a first example of a process executed by a control unit of the information processing device shown in FIG. 2;

FIG. 4 is a second diagram illustrating the first example of the process executed by the control unit of the information processing device shown in FIG. 2;

FIG. 5 is a diagram illustrating a second example of the process executed by the control unit of the information processing device shown in FIG. 2;

FIG. 6 is a diagram illustrating a third example of the process executed by the control unit of the information processing device shown in FIG. 2;

FIG. 7 is a flowchart illustrating a first example of an information processing method executed by the information processing device shown in FIG. 1;

FIG. 8 is a flowchart illustrating a second example of the information processing method executed by the information processing device shown in FIG. 1;

FIG. 9 is a flowchart illustrating a third example of the information processing method executed by the information processing device shown in FIG. 1; and

FIG. 10 is a flowchart illustrating a fourth example of the information processing method executed by the information processing device shown in FIG. 1.

### DETAILED DESCRIPTION OF EMBODIMENTS

Hereinafter, embodiments of the present disclosure will be described below with reference to the drawings.

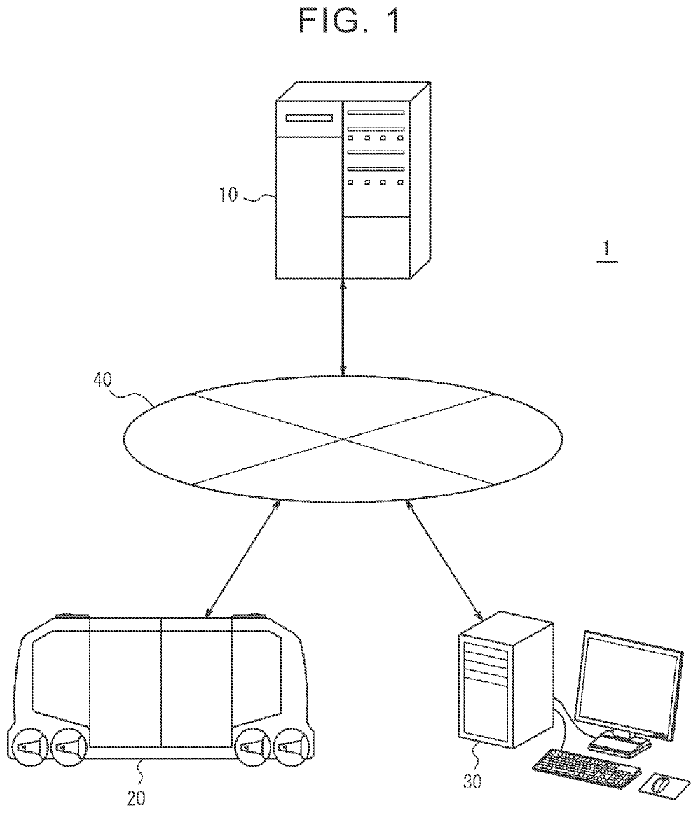

FIG. 1 is a configuration diagram showing a configuration of an information processing system 1 including an information processing device 10 according to an embodiment of the present disclosure. An outline of the information processing system 1 including the information processing device 10 according to the embodiment of the present disclosure will be mainly described with reference to FIG. 1. The information processing system 1 includes a vehicle 20 and a terminal device 30 in addition to the information processing device 10.

For convenience of description, FIG. 1 shows a single information processing device 10, a single vehicle 20, and a single terminal device 30. However, the numbers of the information processing devices 10, the vehicles 20, and the terminal devices 30 included in the information processing system 1 may be two or more. For example, an occupant may continuously use the same vehicle 20, or may use any one of a plurality of the vehicles 20 while changing the vehicle 20 for each ride or by a predetermined period. Each of the information processing device 10, the vehicle 20, and the terminal device 30 is connected to a network 40 including a mobile communication network and the Internet, for example, so as to be able to communicate with each other.

The information processing device 10 is a server or a plurality of servers that can communicate with each other. The information processing device 10 is not limited to the above, and may be any general-purpose electronic device such as a personal computer (PC) or a smartphone, or may be another electronic device dedicated to the information processing system 1.

The vehicle 20 is, for example, an automobile. The vehicle 20 is not limited to this, and may be any vehicle that allows a human to board and drive to a destination. The vehicle 20 is, for example, a vehicle that performs autonomous driving. Autonomous driving includes, for example, Levels 1 to 5 defined by the Society of Automotive Engineers (SAE). However, autonomous driving is not limited to the above, and may be appropriately defined. The vehicle 20 is not limited to the vehicle that performs autonomous driving, and may be any vehicle driven by a driver.

The terminal device 30 is a general-purpose electronic device such as a PC or a smartphone. The terminal device 30 is, for example, an electronic device used by a staff member of a service facility used by an occupant of the vehicle 20. The terminal device 30 is not limited to this, and may be a single server device or a plurality of server devices used in a service facility and capable of communicating with each other, or may be an electronic device dedicated to the information processing system 1. In the present specification, the “service facility” includes facilities that provide services related to retail, accommodation, food and beverage, health, healing, entertainment, and the like.

As an outline of the embodiment, the information processing device 10 acquires first information from a first sensor installed in the vehicle cabin of the vehicle 20 for detecting occupants. The number of occupants of the vehicle 20 may be one or more. In the present specification, the “first sensor” includes, for example, a seating sensor installed in a seat of the vehicle 20 such as a driver's seat, a passenger seat, and a rear seat in which an occupant of the vehicle 20 is seated. The first sensor is not limited to this, and may include a camera module, a microphone, and any other sensor modules installed in the vehicle cabin of the vehicle 20 and connected to the controller area network (CAN).

In the present specification, the “first information” includes, for example, any output information output from the first sensor. For example, the first information includes detection information and numerical information, etc. output from the seating sensor. The first information is not limited to this, and may include image information output from the camera module, or may include audio information output from the microphone.

The information processing device 10 acquires second information from a second sensor for detecting opening and closing of the door of the vehicle 20. In the present specification, the “second sensor” includes, for example, an opening and closing sensor for the door of the vehicle 20 and any other sensor module. In the present specification, the “second information” includes, for example, any output information output from the second sensor. For example, the second information includes detection information output from the opening and closing sensor, the acceleration of the door accompanying the opening and closing of the door, and the like.

The information processing device 10 estimates composition information of the occupants of the vehicle 20 based on the acquired first information. In the present specification, the “composition information” includes, for example, the number, age, gender, weight, physique, and the like of the occupants. The information processing device 10 estimates mood information of the occupants of the vehicle 20 based on the acquired second information. In the present specification, the “mood information” includes, for example, a degree of moodiness and the like.

The degree of moodiness may be expressed based on any index. For example, the degree of moodiness may be represented by a numerical value within any numerical range. For example, the degree of moodiness may be represented by a numerical value from 0 to 100. At this time, the larger the value of the degree of moodiness, the worse the mood of the occupant. In contrast, the smaller the value of the degree of moodiness, the better the mood of the occupant. The degree of moodiness is not limited to these, and may be represented by any of three levels, for example, “high”, “medium”, and “low”.

The information processing device 10 compares the estimated composition information and mood information with past data for other occupants in which the composition information and the mood information are associated with the service content received at the service facility. Thereby, the information processing device 10 determines a service content fit for the occupant of the vehicle 20.

In the present specification, the “past data” includes, for example, big data in which composition information and mood information acquired in the past in relation to other occupants who boarded each of the vehicles 20 are associated with the service content that each of the other occupants received at the service facility.

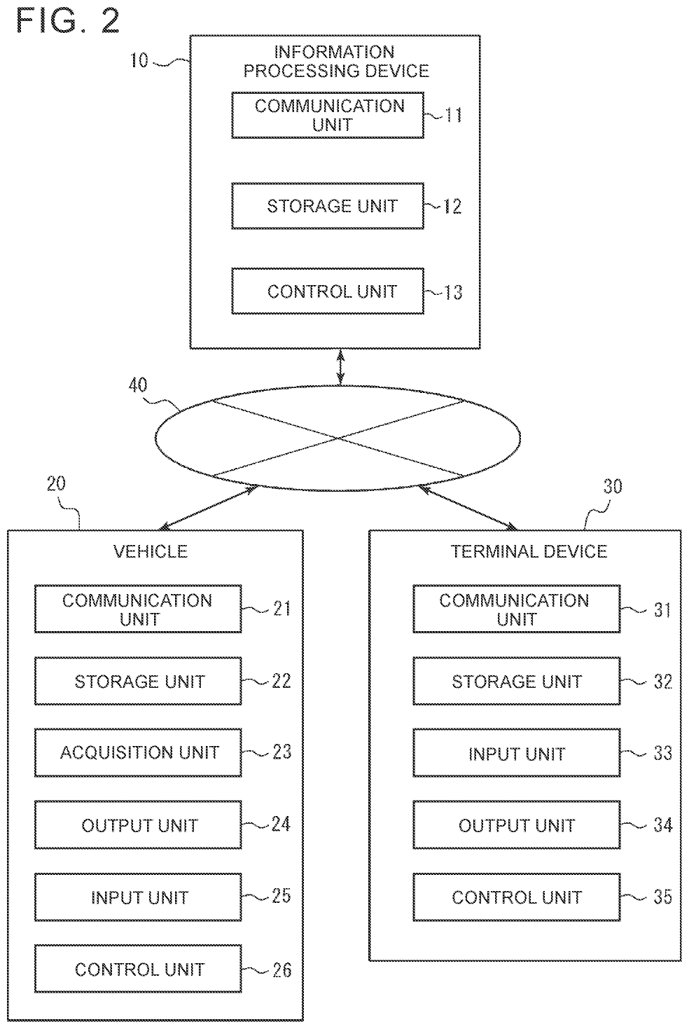

Next, with reference to FIG. 2, configurations of the information processing device 10, the vehicle 20, and the terminal device 30 included in the information processing system 1 will be mainly described. FIG. 2 is a functional block diagram showing a schematic configuration of each of the information processing device 10, the vehicle 20, and the terminal device 30 shown in FIG. 1.

As shown in FIG. 2, the vehicle 20 includes a communication unit 21, a storage unit 22, an acquisition unit 23, an output unit 24, an input unit 25, and a control unit 26. The communication unit 21, the storage unit 22, the acquisition unit 23, the output unit 24, the input unit 25, and the control unit 26 are connected to each other so as to be able to communicate with each other via an in-vehicle network such as a CAN or a dedicated line.

The communication unit 21 includes a communication module connected to the network 40. For example, the communication unit 21 may include a communication module compatible with mobile communication standards such as the fourth generation (4G) and the fifth generation (5G). According to the embodiment, the vehicle 20 is connected to the network 40 via the communication unit 21. The communication unit 21 transmits and receives various types of information via the network 40.

The storage unit 22 is, for example, a semiconductor memory, a magnetic memory, or an optical memory. However, the storage unit 22 is not limited to these memories. The storage unit 22 may function as, for example, a main storage device, an auxiliary storage device, or a cache memory. The storage unit 22 stores any information used for operation of the vehicle 20. For example, the storage unit 22 stores the first information and the second information acquired by the acquisition unit 23. In addition, for example, the storage unit 22 may store a system program, an application program, and various types of information received by the communication unit 21. The information stored in the storage unit 22 may be updatable with information received from the network 40 via the communication unit 21, for example.

The acquisition unit 23 includes the first sensor and the second sensor described above. In addition, the acquisition unit 23 includes one or more receivers corresponding to any satellite positioning system. For example, the acquisition unit 23 may include a global positioning system (GPS) receiver. The acquisition unit 23 acquires a measured value of the position of the vehicle 20 as the position information. The position information includes, for example, an address, latitude, longitude, and altitude. The acquisition unit 23 may acquire the position information of the vehicle 20 constantly or may acquire the position information periodically or irregularly.

The output unit 24 outputs, for example, facility information of the service facility fit for the occupants of the vehicle 20 and determined by the information processing device 10 to the occupants in the vehicle cabin of the vehicle 20. In the present specification, the “facility information of the service facility” includes, for example, information related to the position information, type, and equipment of the service facility. For example, the output unit 24 includes a car navigation device. For example, the output unit 24 includes an output device such as a liquid crystal monitor that constitutes the car navigation device. The car navigation device constituting the output unit 24 outputs, for example, information using at least either of an image and a sound.

The output unit 24 is not limited to this, and may include any output device that affects at least either of visual and auditory senses of the occupant of the vehicle 20. The output unit 24 may include, for example, any audio output device other than the car navigation device, which mainly affects the hearing of the occupants of the vehicle 20. The output unit 24 may include, for example, any image output device other than the car navigation device, which mainly affects the visual sense of the occupants of the vehicle 20.

The input unit 25 includes, for example, one or more input interfaces that receive an input operation by the occupant in response to the information output by the output unit 24 and acquire input information based on the input operation by the occupant. For example, the input unit 25 includes a car navigation device that constitutes the output unit 24. For example, the input unit 25 includes a touch screen provided integrally with the liquid crystal monitor constituting the car navigation device. The car navigation device constituting the input unit 25 receives, for example, the input operation by the occupant based on a touch operation by the occupant.

The input unit 25 is not limited to this, and may include any input interface capable of detecting the input operation by the occupant and acquiring the input information based on the input operation by the occupant. The input unit 25 may include, for example, a physical key, a capacitance key, and a microphone that accepts voice inputs.

The control unit 26 includes one or more processors. According to the embodiment, the “processor” is a general-purpose processor or a dedicated processor specialized for specific processing. However, the processor is not limited thereto. For example, the control unit 26 may include an electronic control unit (ECU). The control unit 26 is connected to each component constituting the vehicle 20 so as to be able to communicate with each other and controls the operation of the entire vehicle 20.

The control unit 26 acquires the first information and the second information for each of the occupants of the vehicle 20 by using the first sensor and the second sensor included in the acquisition unit 23, respectively. The control unit 26 transmits the first information and the second information acquired by the acquisition unit 23 to the information processing device 10 via the communication unit 21 and the network 40.

The control unit 26 receives the facility information of the service facility determined by the information processing device 10 from the information processing device 10 via the network 40 and the communication unit 21. The control unit 26 outputs the facility information of the service facility received from the information processing device 10 to the output unit 24. For example, when there is a plurality of options for the service facility determined by the information processing device 10, the control unit 26 lists on the output unit 24 the facility information of the determined service facilities. The control unit 26 transmits the facility information of the service facility selected by the occupant of the vehicle 20 using the input unit 25 among the options for the service facility displayed in the list to the information processing device 10 via the communication unit 21 and the network 40.

The control unit 26 receives route information to the service facility determined by the information processing device 10 from the information processing device 10 via the network 40 and the communication unit 21. The control unit 26 receives information on the autonomous driving state determined by the information processing device 10 from the information processing device 10 via the network 40 and the communication unit 21. In the present specification, the “information on the autonomous driving state” includes speed, acceleration, angular velocity, shift lever operation, steering operation, traveling lane, and the like of the vehicle 20.

The control unit 26 executes vehicle control for the vehicle 20 based on, for example, the route information to the service facility received from the information processing device 10 and the information on the autonomous driving state. In the present specification, the “vehicle control” includes, but is not limited to, autonomous driving to the service facility serving as a destination, for example. For example, the control unit 26 may only assist the driver of the vehicle 20 by displaying the route information to the service facility received from the information processing device 10 on the output unit 24.

Next, the configuration of the terminal device 30 included in the information processing system 1 will be mainly described. As shown in FIG. 2, the terminal device 30 includes a communication unit 31, a storage unit 32, an input unit 33, an output unit 34, and a control unit 35.

The communication unit 31 includes a communication module connected to the network 40. For example, the communication unit 31 may include a communication module compatible with mobile communication standards such as the 4G and the 5G or the Internet standards. According to the embodiment, the terminal device 30 is connected to the network 40 via the communication unit 31. The communication unit 31 transmits and receives various types of information via the network 40.

The storage unit 32 is, for example, a semiconductor memory, a magnetic memory, or an optical memory. However, the storage unit 32 is not limited to these memories. The storage unit 32 may function as, for example, a main storage device, an auxiliary storage device, or a cache memory. The storage unit 32 stores any information used for the operation of the terminal device 30. For example, the storage unit 32 may store a system program, an application program, and various types of information received by the communication unit 31. The information stored in the storage unit 32 may be updatable with information received from the network 40 via the communication unit 31, for example.

The input unit 33 includes one or more input interfaces that detect user input and acquire input information based on the user's operation. For example, the input unit 33 may include a physical key, a capacitive key, a touch screen integrated with a display of the output unit 34, a microphone that accepts voice input, and the like.

The output unit 34 includes one or more output interfaces that output information to notify the user. For example, the output unit 34 is, but is not limited to, a display that outputs information as images, a speaker that outputs information as audio, and the like.

The control unit 35 includes one or more processors. According to the embodiment, the “processor” is a general-purpose processor or a dedicated processor specialized for specific processing. However, the processor is not limited thereto. The control unit 35 is connected to each of the components constituting the terminal device 30 so as to be able to communicate with each other and controls the operation of the entire terminal device 30.

For example, the control unit 35 receives the service content fit for the occupant of the vehicle 20 determined by the information processing device 10 from the information processing device 10 via the network 40 and the communication unit 31. For example, the control unit 35 transmits the facility information of the service facility stored in the storage unit 32 to the information processing device 10 via the communication unit 31 and the network 40.

Next, the configuration of the information processing device 10 included in the information processing system 1 will be mainly described. As shown in FIG. 2, the information processing device 10 includes a communication unit 11, a storage unit 12, and a control unit 13.

The communication unit 11 includes a communication module connected to the network 40. For example, the communication unit 11 may include a communication module compatible with mobile communication standards such as the 4G and the 5G or the Internet standards. According to the embodiment, the information processing device 10 is connected to the network 40 via the communication unit 11. The communication unit 11 transmits and receives various types of information via the network 40.

The storage unit 12 is, for example, a semiconductor memory, a magnetic memory, or an optical memory. However, the storage unit 12 is not limited to these memories. The storage unit 12 may function as, for example, a main storage device, an auxiliary storage device, or a cache memory. The storage unit 12 stores any information used for the operation of the information processing device 10. For example, the storage unit 12 may store a system program, an application program, and various types of information received by the communication unit 11. The information stored in the storage unit 12 may be updatable with information received from the network 40 via the communication unit 11, for example.

The control unit 13 includes one or more processors. According to the embodiment, the “processor” is a general-purpose processor or a dedicated processor specialized for specific processing. However, the processor is not limited thereto. The control unit 13 is connected to each of the components constituting the information processing device 10 so as to be able to communicate with each other and controls the operation of the entire information processing device 10.

The control unit 13 acquires the first information from the first sensor installed in the vehicle cabin of the vehicle 20 for detecting the occupants and the second information from the second sensor for detecting the opening and closing of the door of the vehicle 20. For example, the control unit 13 receives the first information and the second information acquired by the acquisition unit 23 of the vehicle 20 from the vehicle 20 via the network 40 and the communication unit 11. The control unit 13 estimates the composition information of the occupants based on the acquired first information. The control unit 13 estimates the mood information of the occupants based on the acquired second information.

The control unit 13 compares the estimated composition information and mood information with past data for other occupants in which the composition information and the mood information are associated with the service content received at the service facility. Thereby, the control unit 13 determines the service content fit for the occupant of the vehicle 20. At this time, the control unit 13 may receive in advance the past data from any other external device via the network 40 and the communication unit 11 and store the past data in the storage unit 12.

The control unit 13 provides the determined service content to the terminal device 30 of the service facility used by the occupant of the vehicle 20. For example, the control unit 13 transmits the determined service content to the terminal device 30 via the communication unit 11 and the network 40.

The control unit 13 may estimate the composition information based on the first information acquired at any timing from the time when the vehicle 20 departs from the departure place to the time when the vehicle 20 arrives at the service facility serving as the destination. The control unit 13 may estimate the mood information based on the second information when the vehicle 20 arrives at the service facility serving as the destination. The control unit 13 may determine the service content fit for the occupant based on the estimated information described above. The control unit 13 may provide the service facility with the determined service content fit for the occupant. At this time, the control unit 13 may identify the service facility by comparing, for example, the position information of the vehicle 20 acquired by the acquisition unit 23 of the vehicle 20 with the facility information of the service facility acquired from the terminal device 30.

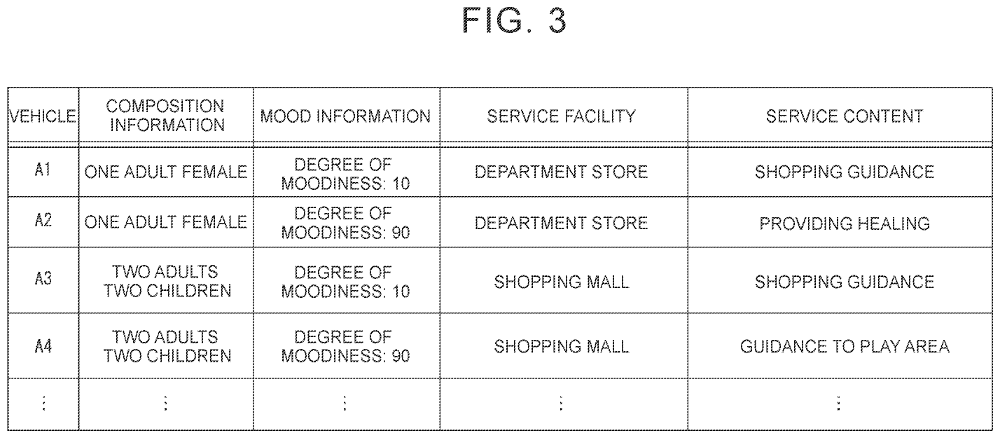

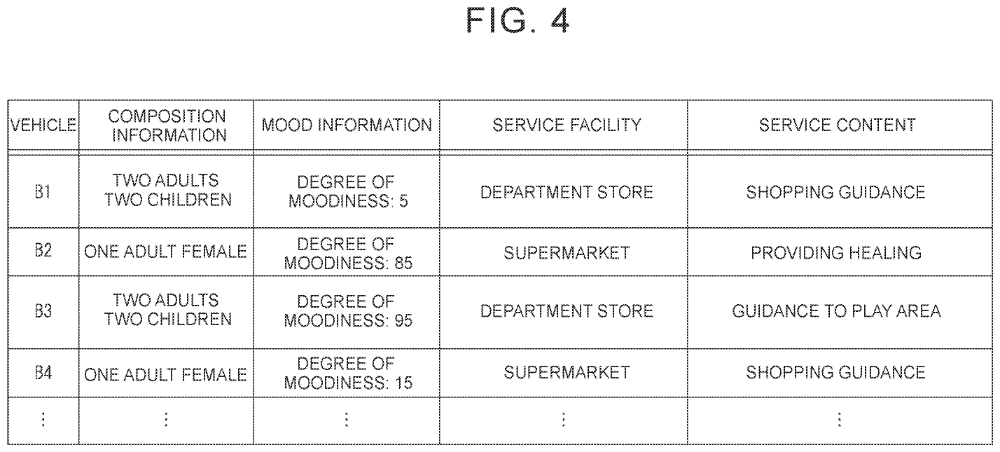

FIG. 3 is a first diagram illustrating a first example of a process executed by the control unit 13 of the information processing device 10 shown in FIG. 2. FIG. 4 is a second diagram illustrating the first example of the process executed by the control unit 13 of the information processing device 10 shown in FIG. 2. FIG. 4 shows an example of the past data. The first example of the process executed by the control unit 13 will be described more specifically with reference to FIGS. 3 and 4.

In the first example of the process executed by the control unit 13, a service content fit for the occupant of the vehicle 20 is determined based on the first information and the second information acquired by the control unit 13. Although four vehicles A1, A2, A3, and A4 are shown in FIG. 3, the number of vehicles 20 corresponding to the service contents determined by the control unit 13 does not have to be four. Similarly, although FIG. 4 shows four vehicles B1, B2, B3, and B4, the number of vehicles 20 included in the past data does not have to be four.

The control unit 13 estimates the information indicating one adult female as the composition information of the occupant based on the first information acquired from the vehicle A1. The control unit 13 acquires the second information indicating that the acceleration of the door accompanying the opening and closing of the door of the vehicle A1 is small, determines that the occupant of the vehicle A1 gently opened and closed the door, and estimates the information indicating the degree of moodiness of 10 as the mood information of the occupant. The control unit 13 determines that the vehicle A1 has arrived at a department store as the service facility by comparing the position information of the vehicle A1 acquired by the acquisition unit 23 of the vehicle A1 with the facility information of the service facility acquired from the terminal device 30.

The control unit 13 compares the estimated composition information indicating one adult female and the estimated mood information indicating the degree of moodiness of 10 with the past data. More specifically, the control unit 13 compares the information about the occupant of the vehicle A1 with the past data for another occupant of the vehicle B4. In the past data for the other occupant of the vehicle B4, the composition information includes the information indicating one adult female. The mood information includes information indicating a degree of moodiness of 15. In this way, the control unit 13 executes the comparison process while referring to the past data of the vehicle B4 including information similar to the composition information and the mood information of the occupant of the vehicle A1.

At this time, the control unit 13 may refer to the facility information of the service facility in addition to the composition information and the mood information in order to improve the accuracy of determining the service content fit for the occupant of the vehicle A1. In the past data for the other occupant of the vehicle B4, the facility information of the service facility used by the other occupant includes information indicating the supermarket. The control unit 13 may execute the comparison process while referring to the past data of the vehicle B4, which includes information similar to the facility information of the service facility of the department store where the vehicle A1 has arrived, in addition to the composition information and the mood information.

In such a comparison process, the control unit 13 refers to “shopping guidance” as the service content received by the other occupant of the vehicle B4 at the service facility. Based on the above, the control unit 13 determines “shopping guidance” as a service content fit for the occupant of the vehicle A1.

The control unit 13 provides the terminal device 30 of the department store with “shopping guidance” as a service content fit for the occupant of the vehicle A1. As a result, the staff member of the department store can provide, for example, the “shopping guidance” displayed on the output unit 34 of the terminal device 30 to the occupant of the vehicle A1 as a service content fit for the occupant. For example, the staff member of the department store may introduce recommended products at the facility to the occupant of the vehicle A1 at the entrance of the department store or the like.

The control unit 13 estimates information indicating one adult female as the composition information of the occupant based on the first information acquired from the vehicle A2. The control unit 13 acquires the second information indicating that the acceleration of the door accompanying the opening and closing of the door of the vehicle A2 is large, determines that the occupant of the vehicle A2 forcefully opened and closed the door, and estimates the information indicating the degree of moodiness of 90 as the mood information of the occupant. The control unit 13 determines that the vehicle A2 has arrived at the department store as a service facility by comparing the position information of the vehicle A2 acquired by the acquisition unit 23 of the vehicle A2 with the facility information of the service facility acquired from the terminal device 30.

The control unit 13 compares the estimated composition information indicating one adult female and the estimated mood information indicating the degree of moodiness of 90 with the past data. More specifically, the control unit 13 compares the information about the occupant of the vehicle A2 with the past data for another occupant of the vehicle B2. In the past data for the other occupant of the vehicle B2, the composition information includes information indicating one adult female. The mood information includes information indicating a degree of moodiness of 85. In this way, the control unit 13 executes the comparison process while referring to the past data of the vehicle B2 including information similar to the composition information and the mood information of the occupant of the vehicle A2.

At this time, the control unit 13 may refer to the facility information of the service facility in addition to the composition information and the mood information in order to improve the accuracy of determining the service content fit for the occupant of the vehicle A2. In the past data for the other occupant of the vehicle B2, the facility information of the service facility used by the other occupant includes information indicating the supermarket. The control unit 13 may execute the comparison process while referring to the past data of the vehicle B2, which includes information similar to the facility information of the service facility of the department store where the vehicle A2 has arrived, in addition to the composition information and the mood information.

In such a comparison process, the control unit 13 refers to “providing healing” as the service content received by the other occupant of the vehicle B2 at the service facility. Based on the above, the control unit 13 determines “providing healing” as a service content fit for the occupant of the vehicle A2.

The control unit 13 provides the terminal device 30 of the department store with “providing healing” as a service content fit for the occupant of the vehicle A2. As a result, the staff member of the department store can provide, for example, the “providing healing” displayed on the output unit 34 of the terminal device 30 to the occupant of the vehicle A2 as a service content fit for the occupant. For example, the staff member of the department store may provide healing music to the occupant of the vehicle A2 in the department store or scent the department store with aroma oil or the like.

The control unit 13 estimates information indicating two adults and two children as the composition information of the occupants based on the first information acquired from the vehicle A3. The control unit 13 acquires the second information indicating that the acceleration of the door accompanying the opening and closing of the door of the vehicle A3 is small, determines that the occupants of the vehicle A3 gently opened and closed the door, and estimates the information indicating the degree of moodiness of 10 as the mood information of the occupants. When there is a plurality of occupants as in the case of the vehicle A3, the control unit 13 may calculate the average value of the mood information estimated based on the second information of each of the occupants. That is, the mood information indicating the degree of moodiness of 10 acquired in relation to the vehicle A3 may be an average value calculated for the plurality of occupants.

The control unit 13 determines that the vehicle A3 has arrived at a shopping mall as a service facility by comparing the position information of the vehicle A3 acquired by the acquisition unit 23 of the vehicle A3 with the facility information of the service facility acquired from the terminal device 30.

The control unit 13 compares the estimated composition information indicating two adults and two children and the estimated mood information indicating the degree of moodiness of 10 with the past data. More specifically, the control unit 13 compares the information about the occupants of the vehicle A3 with the past data for other occupants of the vehicle B1. In the past data for the other occupants of the vehicle B1, the composition information includes information indicating two adults and two children. The mood information includes information indicating a degree of moodiness of 5. In this way, the control unit 13 executes the comparison process while referring to the past data of the vehicle B1 including information similar to the composition information and the mood information of the occupants of the vehicle A3.

At this time, the control unit 13 may refer to the facility information of the service facility in addition to the composition information and the mood information in order to improve the accuracy of determining the service content fit for the occupants of the vehicle A3. In the past data for the other occupants of the vehicle B1, the facility information of the service facility used by the other occupants includes the information indicating the department store. The control unit 13 may execute the comparison process while referring to the past data of the vehicle B1, which includes information similar to the facility information of the service facility of the shopping mall where the vehicle A3 has arrived, in addition to the composition information and the mood information.

In such a comparison process, the control unit 13 refers to “shopping guidance” as the service content received by the other occupants of the vehicle B1 at the service facility. Based on the above, the control unit 13 determines “shopping guidance” as a service content fit for the occupants of the vehicle A3.

The control unit 13 provides the terminal device 30 of the shopping mall with “shopping guidance” as a service content fit for the occupants of the vehicle A3. As a result, the staff member of the shopping mall can provide, for example, the “shopping guidance” displayed on the output unit 34 of the terminal device 30 to the occupants of the vehicle A3 as a service content fit for the occupants. For example, the staff member of the shopping mall may introduce the recommended products at the facility to the occupants of the vehicle A3 at the entrance of the shopping mall or the like.

The control unit 13 estimates information indicating two adults and two children as the composition information of the occupants based on the first information acquired from the vehicle A4. The control unit 13 acquires the second information indicating that the acceleration of the door accompanying the opening and closing of the door of the vehicle A4 is large, determines that the occupants of the vehicle A4 forcefully opened and closed the door, and estimates the information indicating the degree of moodiness of 90 as the mood information of the occupants. When there is a plurality of occupants as in the case of the vehicle A4, the control unit 13 may calculate the average value of the mood information estimated based on the second information of each of the occupants. That is, the mood information indicating the degree of moodiness of 90 acquired in relation to the vehicle A4 may be an average value calculated for the plurality of occupants.

The control unit 13 determines that the vehicle A4 has arrived at a shopping mall as a service facility by comparing the position information of the vehicle A4 acquired by the acquisition unit 23 of the vehicle A4 with the facility information of the service facility acquired from the terminal device 30.

The control unit 13 compares the estimated composition information indicating two adults and two children and the estimated mood information indicating the degree of moodiness of 90 with the past data. More specifically, the control unit 13 compares the information about the occupants of the vehicle A4 with the past data for other occupants of the vehicle B3. In the past data for the other occupants of the vehicle B3, the composition information includes information indicating two adults and two children. The mood information includes information indicating a degree of moodiness of 95. In this way, the control unit 13 executes the comparison process while referring to the past data of the vehicle B3 including information similar to the composition information and the mood information of the occupants of the vehicle A4.

At this time, the control unit 13 may refer to the facility information of the service facility in addition to the composition information and the mood information in order to improve the accuracy of determining the service content fit for the occupants of the vehicle A4. In the past data for the other occupants of the vehicle B3, the facility information of the service facility used by the other occupants includes the information indicating the department store. The control unit 13 may execute the comparison process while referring to the past data of the vehicle B3, which includes information similar to the facility information of the service facility of the shopping mall where the vehicle A4 has arrived, in addition to the composition information and the mood information.

In such a comparison process, the control unit 13 refers to “guidance to a play area” as the service content received by the other occupants of the vehicle B3 at the service facility. Based on the above, the control unit 13 determines “guidance to the play area” as a service content fit for the occupants of the vehicle A4.

The control unit 13 provides the terminal device 30 of the shopping mall with “guidance to the play area” as a service content fit for the occupants of the vehicle A4. As a result, the staff member of the shopping mall can provide, for example, the “guidance to the play area” displayed on the output unit 34 of the terminal device 30 to the occupants of the vehicle A4 as a service content fit for the occupants. For example, the staff member of the shopping mall may guide the location of the play area provided in the facility to the occupants of the vehicle A4 at the entrance of the shopping mall or the like, or may take the occupants of the vehicle A4 to the play area.

In the above, the service facility related to the service content determined by the control unit 13 has been described as the facility where the vehicle 20 has actually arrived, but the service facility is not limited to this. For example, the control unit 13 may estimate the composition information and the mood information based on the first information and the second information, respectively, when the vehicle 20 departs from the departure place, and determine the service facility fit for the occupant of the vehicle 20 based on the estimated composition information and mood information and the information on the type of the service facility acquired from the vehicle 20 as a destination option. For example, the control unit 13 receives information on the type of the service facility input by the occupant as a destination option using the input unit 25 of the vehicle 20 from the vehicle 20 via the network 40 and the communication unit 11.

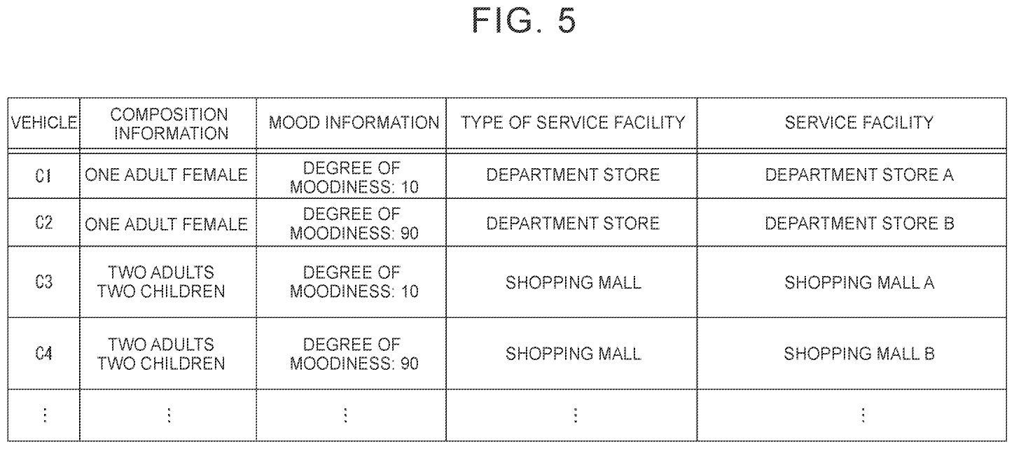

FIG. 5 is a diagram illustrating a second example of the process executed by the control unit 13 of the information processing device 10 shown in FIG. 2. The second example of the process executed by the control unit 13 will be described more specifically with reference to FIG. 5.

In the second example of the process executed by the control unit 13, the service facility fit for the occupant of the vehicle 20 is determined based on the first information and the second information acquired by the control unit 13 and the information on the type of the service facility serving as a destination option. Although four vehicles C1, C2, C3, and C4 are shown in FIG. 5, the number of vehicles 20 corresponding to the service facilities determined by the control unit 13 does not have to be four.

The control unit 13 estimates the composition information indicating one adult female and the mood information indicating the degree of moodiness of 10 based on the first information and the second information when the vehicle C1 departs from the departure place. In addition, the control unit 13 acquires, for example, information on the type of the service facility indicating a department store input by the occupant as a destination option using the input unit 25 of the vehicle C1. The control unit 13 determines the department store A as a service facility fit for the occupant of the vehicle C1 based on the estimated information and the acquired information on the type of the service facility indicating the department store. The department store A is, for example, a department store that can provide a service of shopping guidance among a plurality of department stores located within a predetermined range from the departure place of the vehicle C1.

The control unit 13 estimates the composition information indicating one adult female and the mood information indicating the degree of moodiness of 90 based on the first information and the second information when the vehicle C2 departs from the departure place. In addition, the control unit 13 acquires, for example, information on the type of the service facility indicating a department store input by the occupant as a destination option using the input unit 25 of the vehicle C2. The control unit 13 determines the department store B as a service facility fit for the occupant of the vehicle C2 based on the estimated information and the acquired information on the type of the service facility indicating the department store. The department store B is, for example, a department store that can provide a service of providing healing and at which the vehicle C2 can arrive in the shortest time among a plurality of department stores located within a predetermined range from the departure place of the vehicle C2.

The control unit 13 estimates the composition information indicating two adults and two children and the mood information indicating the degree of moodiness of 10 based on the first information and the second information when the vehicle C3 departs from the departure place. In addition, the control unit 13 acquires, for example, information on the type of the service facility indicating a shopping mall input by the occupants as a destination option using the input unit 25 of the vehicle C3. The control unit 13 determines the shopping mall A as a service facility fit for the occupants of the vehicle C3 based on the estimated information and the acquired information on the type of the service facility indicating the shopping mall. The shopping mall A is, for example, a shopping mall that can provide a service of shopping guidance among a plurality of shopping malls located within a predetermined range from the departure place of the vehicle C3.

The control unit 13 estimates the composition information indicating two adults and two children and the mood information indicating the degree of moodiness of 90 based on the first information and the second information when the vehicle C4 departs from the departure place. In addition, the control unit 13 acquires, for example, information on the type of the service facility indicating a shopping mall input by the occupants as a destination option using the input unit 25 of the vehicle C4. The control unit 13 determines the shopping mall B as a service facility fit for the occupants of the vehicle C4 based on the estimated information and the acquired information on the type of the service facility indicating the shopping mall. The shopping mall B is, for example, a shopping mall that can provide a service of guidance to the play area and at which the vehicle C4 can arrive in the shortest time among a plurality of shopping malls located within a predetermined range from the departure place of the vehicle C4.

The control unit 13 may notify the occupant of the vehicle 20 of the facility information of the service facility determined as described above. For example, the control unit 13 transmits the facility information of the determined service facility to the vehicle 20 via the communication unit 11 and the network 40. In addition, the control unit 13 may determine the route information to the service facility based on the facility information of the determined service facility. The control unit 13 may provide the determined route information to the vehicle 20. For example, the control unit 13 may transmit the determined route information to the vehicle 20 via the communication unit 11 and the network 40.

As shown in FIG. 5, it has been described that the control unit 13 determines one service facility for the occupant of the vehicle 20, but the present disclosure is not limited to this. The control unit 13 may determine a plurality of options for the service facility fit for the occupant of the vehicle 20. The control unit 13 may notify the occupant of the vehicle 20 of the facility information of each of the determined service facilities. For example, the control unit 13 transmits the facility information of each of the determined service facilities to the vehicle 20 via the communication unit 11 and the network 40.

For example, the control unit 13 receives the facility information of the service facility selected by the occupant using the input unit 25 of the vehicle 20 among the determined options for the service facility from the vehicle 20 via the network 40 and the communication unit 11. The control unit 13 may determine the route information to the service facility based on the facility information of the service facility received from the vehicle 20. The control unit 13 may provide the determined route information to the vehicle 20. For example, the control unit 13 may transmit the determined route information to the vehicle 20 via the communication unit 11 and the network 40.

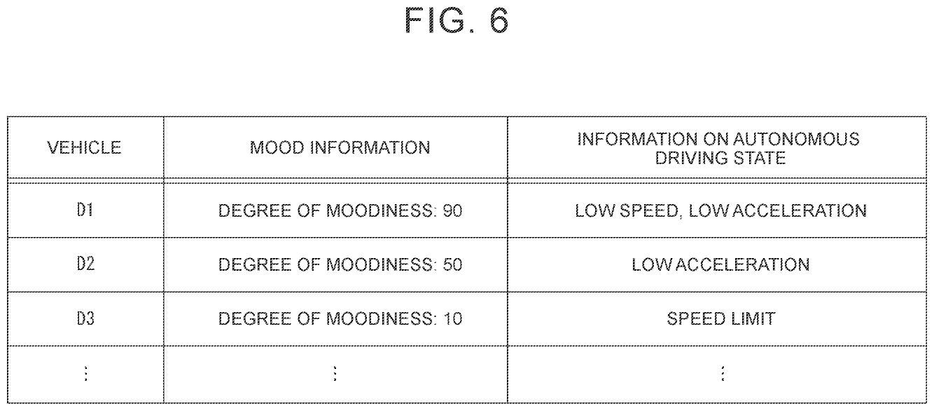

FIG. 6 is a diagram illustrating a third example of the process executed by the control unit 13 of the information processing device 10 shown in FIG. 2. The third example of the process executed by the control unit 13 will be described more specifically with reference to FIG. 6.

In the third example of the process executed by the control unit 13, the control unit 13 may determine the information on the autonomous driving state fit for the mood information estimated based on the second information when the vehicle 20 departs from the departure place and provide the information to the vehicle 20. For example, the control unit 13 may transmit the determined information on the autonomous driving state to the vehicle 20 via the communication unit 11 and the network 40. Although three vehicles D1, D2, and D3 are shown in FIG. 6, the number of vehicles 20 corresponding to the information on the autonomous driving state determined by the control unit 13 does not have to be three.

The control unit 13 estimates the information indicating the degree of moodiness of 90 as the mood information of the occupant of the vehicle D1. At this time, the control unit 13 determines the information on the autonomous driving state fit for the estimated mood information indicating the degree of moodiness of 90. For example, the control unit 13 determines the information on the autonomous driving state indicating low speed and low acceleration and provides the information to the vehicle D1 so that the occupant of the vehicle D1 having a high degree of moodiness can be provided with stable driving of the vehicle D1.

The control unit 13 estimates the information indicating the degree of moodiness of 50 as the mood information of the occupant of the vehicle D2. At this time, the control unit 13 determines the information on the autonomous driving state fit for the estimated mood information indicating the degree of moodiness of 50. For example, the control unit 13 determines the information on the autonomous driving state indicating low acceleration and provides the information to the vehicle D2 so that the occupant of the vehicle D2 having a moderate degree of moodiness can be provided with relatively stable driving of the vehicle D2.

The control unit 13 estimates the information indicating the degree of moodiness of 10 as the mood information of the occupant of the vehicle D3. At this time, the control unit 13 determines the information on the autonomous driving state fit for the estimated mood information indicating the degree of moodiness of 10. For example, the control unit 13 determines the information on the autonomous driving state indicating speed limit and provides the information to the vehicle D3, in order to enable the occupant of the vehicle D3 having a low degree of moodiness to arrive at the destination in the shortest possible time.

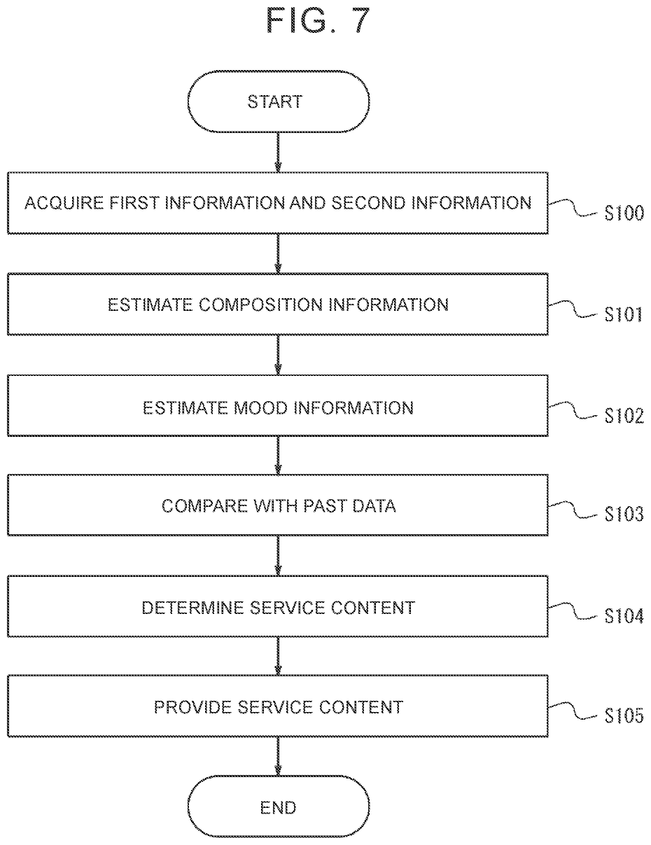

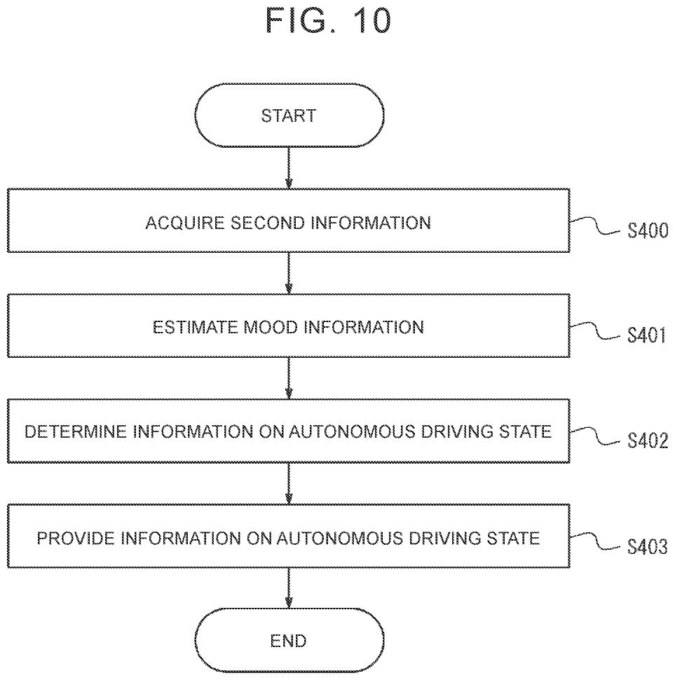

Next, an information processing method executed by the control unit 13 of the information processing device 10 according to the embodiment will be described with reference to FIGS. 7 and 10. FIG. 7 is a flowchart illustrating a first example of the information processing method executed by the information processing device 10 shown in FIG. 1. In the first example of the information processing method, an example of a basic flow of the process executed by the control unit 13 of the information processing device 10 will be described.

In step S100, the control unit 13 acquires the first information from the first sensor installed in the vehicle cabin of the vehicle 20 for detecting the occupants and the second information from the second sensor for detecting the opening and closing of the door of the vehicle 20.

In step S101, the control unit 13 estimates the composition information of the occupant of the vehicle 20 based on the first information acquired in step S100.

In step S102, the control unit 13 estimates the mood information of the occupant of the vehicle 20 based on the second information acquired in step S100.

In step S103, the control unit 13 compares the composition information and the mood information estimated in steps S101 and S102, respectively, with past data for other occupants in which the composition information and the mood information are associated with the service content received at the service facility.

In step S104, the control unit 13 determines a service content fit for the occupant of the vehicle 20 based on the comparison process in step S103.

In step S105, the control unit 13 provides the service content determined in step S104 to the terminal device 30 of the service facility used by the occupant of the vehicle 20.

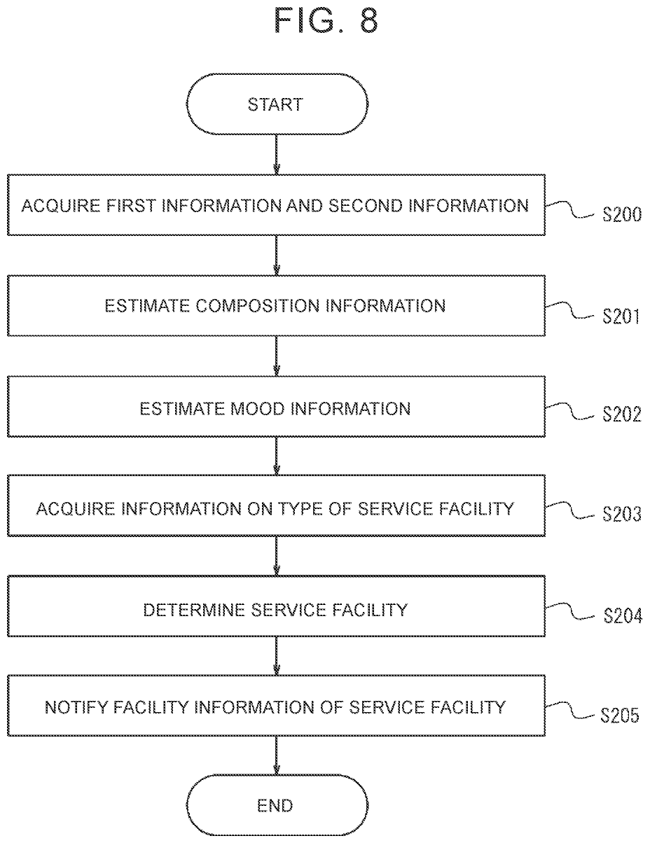

FIG. 8 is a flowchart illustrating a second example of the information processing method executed by the information processing device 10 shown in FIG. 1.

FIG. 8 shows, for example, an example of a process executed by the control unit 13 based on the first information and the second information when the vehicle 20 departs from the departure place.

In step S200, the control unit 13 acquires the first information and the second information when the vehicle 20 departs from the departure place.

In step S201, the control unit 13 estimates the composition information based on the first information acquired in step S200.

In step S202, the control unit 13 estimates the mood information based on the second information acquired in step S200.

In step S203, the control unit 13 acquires information on the type of the service facility as a destination option from the vehicle 20.

In step S204, the control unit 13 determines the service facility fit for the occupant of the vehicle 20 based on the composition information and the mood information estimated in steps S201 and S202, respectively, and the information on the type of the service facility acquired from the vehicle 20 as a destination option in step S203.

In step S205, the control unit 13 notifies the occupant of the vehicle 20 of the facility information of the service facility determined in step S204.

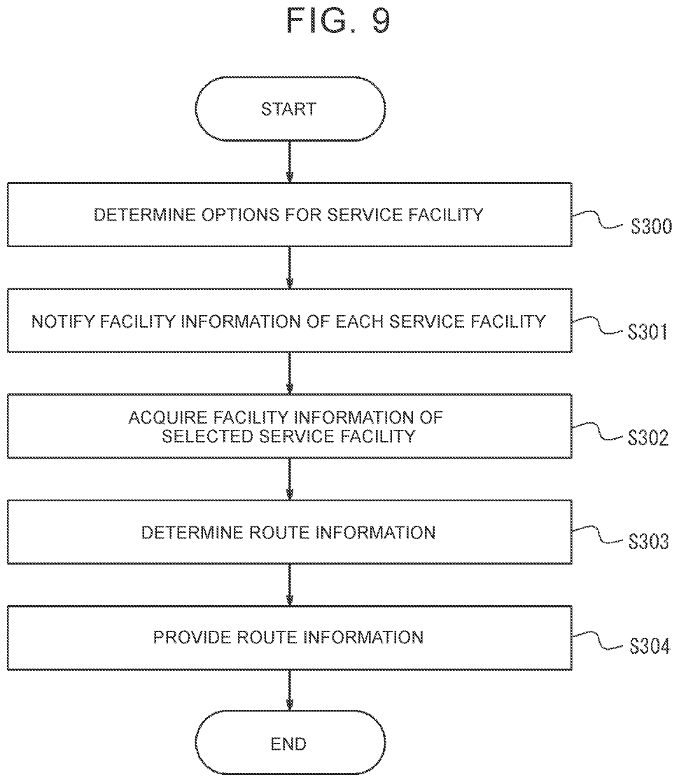

FIG. 9 is a flowchart illustrating a third example of the information processing method executed by the information processing device 10 shown in FIG. 1. FIG. 9 shows an example of the process executed by the control unit 13 at the determination process and the subsequent processes when a plurality of options for the service facility are determined in step S204 of FIG. 8.

In step S300, the control unit 13 determines the options for the service facility fit for the occupant of the vehicle 20.

In step S301, the control unit 13 notifies the occupant of the vehicle 20 of the facility information of each of the service facilities determined in step S300.

In step S302, the control unit 13 acquires the facility information of the service facility selected by the occupant using the input unit 25 of the vehicle 20 among the options for the service facility determined in step S300.

In step S303, the control unit 13 determines the route information to the service facility based on the facility information of the service facility acquired in step S302.

In step S304, the control unit 13 provides the vehicle 20 with the route information determined in step S303.

FIG. 10 is a flowchart illustrating a fourth example of the information processing method executed by the information processing device 10 shown in FIG. 1. FIG. 10 shows an example of the process executed by the control unit 13 in parallel with or at a different timing from the subsequent flow of FIG. 8 when the second information is acquired in step S200 and the mood information is estimated in step S202 of FIG. 8.

In step S400, the control unit 13 acquires the second information when the vehicle 20 departs from the departure place.

In step S401, the control unit 13 estimates the mood information based on the second information acquired in step S400.

In step S402, the control unit 13 determines the information on the autonomous driving state fit for the mood information estimated in step S401.

In step S403, the control unit 13 provides the vehicle 20 with the information on the autonomous driving state determined in step S402.

According to the embodiment described above, the service for the occupant of the vehicle 20 can be optimized based on the composition and mood of the occupant. For example, the information processing device 10 can determine the service content fit for the composition and mood of the occupant by estimating the composition information and the mood information of the occupant based on the acquired first information and second information, respectively. In addition, the information processing device 10 can accurately determine a service content fit for the occupant of the vehicle 20 by comparing the estimated composition information and mood information with the past data.

As described above, the staff member of the service facility who has been provided with the determined service content can provide the optimum service potentially desired by the occupant of the vehicle 20 based on the composition and mood of the occupant. That is, unlike the case in the related art where only a uniform service can be provided for each customer at the service facility, the service optimized for each occupant of the vehicle 20 can be provided at the service facility. Therefore, the quality of the service provided to the occupant at the service facility is improved, and the degree of satisfaction of the occupant as a customer with respect to the service received at the service facility is also improved. As a result, the rate of attracting customers to the service facility will also improve, which in turn will improve management efficiency.

The information processing device 10 can propose, for an occupant who is in a good mood, a service content such as shopping guidance to the service facility in response to the potential request of the occupant who wants to enjoy shopping, and satisfy the request of the occupant. The information processing device 10 can propose, for an occupant who is in a bad mood, a service content such as providing healing to the service facility in response to the potential request of the occupant who wants to calm down while having to shop, and satisfy the request of the occupant.

The information processing device 10 can accurately determine the service content fit for the occupant at the service facility by estimating the mood information based on the second information when the vehicle 20 arrives at the service facility serving as the destination. For example, the mood information of the occupant when the vehicle 20 arrives at the service facility reflects the mood of the occupant immediately before the occupant receives the service at the service facility. Therefore, by determining the service content fit for the occupant based on such mood information and providing the service content to the service facility, the staff member of the service facility can appropriately provide the service based on the mood of the occupant of the vehicle 20 immediately before the occupant receives the service at the service facility.

The information processing device 10 can determine the service facility fit for the composition and the mood of the occupant at the time of departure by estimating the composition information and the mood information based on the first information and the second information, respectively, when the vehicle 20 departs from the departure place. In addition, the information processing device 10 can accurately determine the service facility fit for the occupant of the vehicle 20 by acquiring information on the type of the service facility as a destination option input by the occupant of the vehicle 20, for example. In this way, the occupant heading for the service facility determined by the information processing device 10 can receive the potentially desired service content at the service facility. As a result, the potential request of the occupant for the service is met, which improves the degree of satisfaction of the occupant.

The information processing device 10 provides the vehicle 20 with the route information to the service facility selected by the occupant of the vehicle 20, so that the information processing device 10 can execute vehicle control on the vehicle 20 to the service facility explicitly desired by the occupant. The vehicle 20 can appropriately guide the occupant to the service facility selected by the occupant.

The information processing device 10 determines the information on the autonomous driving state fit for the mood information of the occupant and provides the information to the vehicle 20, so that the vehicle 20 can realize the optimum autonomous driving state fit for the mood of the occupant. Thus, stress of the autonomous driving that the occupant of the vehicle 20 feels is relieved, which improves the comfort of the occupant with the autonomous driving of the vehicle 20.

Since the first sensor includes the seating sensor, the information processing device 10 can accurately estimate the composition information of the occupants seated in the seats of the vehicle 20.

Since the second information includes the acceleration of the door accompanying the opening and closing of the door of the vehicle 20, the information processing device 10 can easily acquire information on how and with what force the occupant of the vehicle 20 opened and closed the door. Therefore, the information processing device 10 can accurately estimate the mood information of the occupants of the vehicle 20 based on such second information.

The information processing device 10 can accurately determine a service content fit for the occupant by comparing the estimated composition information and mood information with the past data including big data.

Although the present disclosure has been described above based on the drawings and the embodiments, it should be noted that those skilled in the art can make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, at least a part of the processing operations executed by the information processing device 10 in the above embodiment may be executed by the vehicle 20. For example, instead of the information processing device 10, the vehicle 20 itself may execute the processing operations described above related to the information processing device 10. At least a part of the processing operations executed by the vehicle 20 may be executed by the information processing device 10.

For example, a general-purpose electronic device such as a smartphone or a computer may be configured to function as the information processing device 10 according to the above embodiment. Specifically, a program including processing content for realizing each function of the information processing device 10 and the like according to the embodiment is stored in a memory of the electronic device, and the program is read and executed by the processor of the electronic device. Thus, the disclosure according to the embodiment can also be realized as a program that can be executed by the processor. Alternatively, the disclosure according to the embodiment can also be realized as a non-transitory computer-readable medium that stores a program executable by one or more processors to cause the information processing device 10 etc. according to the embodiment to execute each function. It should be understood that the above configurations are also included in the scope of the present disclosure.

For example, the information processing device 10 described in the above embodiment may be mounted on the vehicle 20. With the configuration above, the information processing device 10 may directly perform information communication with the vehicle 20 without the network 40.

In the above embodiment, it has been described that the information processing device 10 determines the service content fit for the occupant based on the second information when the vehicle 20 arrives at the service facility serving as the destination, but the present disclosure is not limited to this. The information processing device 10 may determine the service content fit for the occupant based on the second information when the vehicle 20 departs from the departure place. The information processing device 10 may provide the service content determined in this way to a service facility fit for the occupant of the vehicle 20 determined based on the first information and the second information when the vehicle 20 departs from the departure place, or alternatively, provide the service content to the service facility where the vehicle 20 has actually arrived regardless of the determination made by the information processing device 10.

The information processing device 10 may once determine the service content fit for the occupant based on the second information when the vehicle 20 departs from the departure place, and determine again the service content fit for the occupant based on the second information when the vehicle 20 arrives at the service facility serving as the destination. That is, the information processing device 10 may update the service content once determined at the time of departure with the service content determined again at the time of arrival.

In the above embodiment, it has been described that the information processing device 10 determines the service content fit for the occupant based on the first information when the vehicle 20 departs from the departure place, but the present disclosure is not limited to this. The information processing device 10 may determine the service facility fit for the occupant based on the first information acquired at any timing after the vehicle 20 departs from the departure place.

In the above embodiment, it has been described that the information processing device 10 determines the service content fit for the occupant based on the information on the type of the service facility acquired from the vehicle 20 as a destination option, but the present disclosure is not limited to this. The information processing device 10 may determine the service facility fit for the occupant based on a driving history associated with the occupant of the vehicle 20 in place of or in addition to the information on the type of the service facility serving as a destination option.

In the above embodiment, it has been described that the information processing device 10 provides the vehicle 20 with the information determined by the information processing device 10, such as the facility information of the service facility and the route information to the service facility, but the present disclosure is not limited to this. The information processing device 10 may provide the terminal device of the occupant of the vehicle 20, in place of or in addition to the vehicle 20, with the above information. With the configuration above, the information processing system 1 may include the terminal device of the occupant of the vehicle 20 in addition to the information processing device 10, the vehicle 20, and the terminal device 30.

In the above embodiment, it has been described that the information processing system 1 includes the information processing device 10, the vehicle 20, and the terminal device 30, but the present disclosure is not limited thereto. The information processing system 1 may include only the information processing device 10 and the vehicle 20 without the terminal device 30 of the service facility.

In the above embodiment, it has been described that the past data includes, for example, big data, but the present disclosure is not limited to this. The past data may include any data in which the composition information and the mood information acquired in the past in relation to the other occupants are associated with the service contents received by the other occupants at the service facilities.

In the above embodiment, it has been described that the information processing device 10 acquires the past data from any other external device via the network 40 and the communication unit 11, but the present disclosure is not limited to this. The information processing device 10 itself may generate the past data in which the composition information and the mood information acquired in the past in relation to other occupants are associated with the service contents received by the other occupants at the service facilities and store the past data in the storage unit 12.

What is claimed is:

1. An information processing device comprising:
a control unit that determines a service content fit for an occupant by acquiring first information from a first sensor installed in a vehicle cabin of a vehicle for detecting the occupant and second information from a second sensor for detecting opening and closing of a door of the vehicle, estimating composition information of the occupant based on the first information that is acquired, estimating mood information of the occupant based on the second information that is acquired, and comparing the composition information and the mood information that are estimated with past data for another occupant in which the composition information and the mood information are associated with a service content received at a service facility.

2. The information processing device according to claim 1, wherein the control unit estimates the mood information based on the second information when the vehicle arrives at a service facility, and provides the service facility with the service content that is determined and that is fit for the occupant.

3. The information processing device according to claim 1, wherein the control unit estimates the composition information and the mood information based on the first information and the second information, respectively, when the vehicle departs from a departure place, and determines a service facility fit for the occupant based on the composition information and the mood information that are estimated and information on a type of the service facility acquired from the vehicle as a destination option.

4. The information processing device according to claim 3, wherein the control unit determines a plurality of options for the service facility fit for the occupant, and provides the vehicle with route information to the service facility selected by the occupant among the options for the service facility that are determined.

5. The information processing device according to claim 3, wherein the control unit determines information on an autonomous driving state fit for the mood information that is estimated and provides the information to the vehicle.

6. The information processing device according to claim 1, wherein the first sensor includes a seating sensor.

7. The information processing device according to claim 1, wherein the second information includes acceleration of the door accompanying the opening and the closing of the door.

8. An information processing system comprising:
the information processing device according to claim 1; and
the vehicle that provides the information processing device with the first information and the second information.

9. A program that causes an information processing device to perform operations including:
acquiring first information from a first sensor installed in a vehicle cabin of a vehicle for detecting an occupant and second information from a second sensor for detecting opening and closing of a door of the vehicle;
estimating composition information of the occupant based on the first information that is acquired;
estimating mood information of the occupant based on the second information that is acquired;
comparing the composition information and the mood information that are estimated with past data for another occupant in which the composition information and the mood information are associated with a service content received at a service facility; and
determining a service content fit for the occupant.

10. The program according to claim 9, wherein the operations include estimating the mood information based on the second information when the vehicle arrives at a service facility, and providing the service facility with the service content that is determined and that is fit for the occupant.

11. The program according to claim 9, wherein the operations include estimating the composition information and the mood information based on the first information and the second information, respectively, when the vehicle departs from a departure place, and determining the service facility fit for the occupant based on the composition information and the mood information that are estimated and information on a type of the service facility acquired from the vehicle as a destination option.

12. The program according to claim 11, wherein the operations include determining a plurality of options for the service facility fit for the occupant, determining route information to the service facility selected by the occupant among the options for the service facility that are determined, and providing the vehicle with the route information that is determined.

13. The program according to claim 11, wherein the operations include determining information on an autonomous driving state fit for the mood information that is estimated, and providing the vehicle with the information on the autonomous driving state that is determined.

14. The program according to claim 9, wherein the first sensor includes a seating sensor.

15. A vehicle comprising a control unit that determines a service content fit for an occupant by acquiring first information from a first sensor installed in a vehicle cabin of the vehicle for detecting the occupant and second information from a second sensor for detecting opening and closing of a door of the vehicle, estimating composition information of the occupant based on the first information that is acquired, estimating mood information of the occupant based on the second information that is acquired, and comparing the composition information and the mood information that are estimated with past data for another occupant in which the composition information and the mood information are associated with a service content received at a service facility.

16. The vehicle according to claim 15, wherein the control unit estimates the mood information based on the second information when the vehicle arrives at a service facility, and provides the service facility with the service content that is determined and that is fit for the occupant.

17. The vehicle according to claim 15, wherein the control unit estimates the composition information and the mood information based on the first information and the second information, respectively, when the vehicle departs from a departure place, and determines a service facility fit for the occupant based on the composition information and the mood information that are estimated and information on a type of the service facility that is acquired as a destination option.

18. The vehicle according to claim 17, wherein the control unit determines a plurality of options for the service facility fit for the occupant, and determines route information to the service facility selected by the occupant among the options for the service facility that are determined.

19. The vehicle according to claim 17, wherein the control unit determines information on an autonomous driving state fit for the mood information that is estimated.

20. The vehicle according to claim 15, wherein the first sensor includes a seating sensor.
